(19) United States
(12) Patent Application Publication
(10) Pub. No.: US 2009/0160694 A1
(43) Pub. Date: Jun. 25, 2009

(54) Interaction with autonomous consumer electronics devices

(76) Inventor: Cristiano Di Flora, Lempaala (FI)

Correspondence Address: Hollingsworth & Funk, LLC, 8009 34th Avenue South, Suite 125, Minneapolis, MN, 54425, US

(21) Appl. No.: 12/004,197

(22) Filed: Dec. 20, 2007

(51) Int. Cl. H04L 17/02

(52) U.S. Cl. 341/176

(57) ABSTRACT

Interaction with autonomous consumer devices involves representing, on a mobile device, a target entity that is commonly accessible by applications of the mobile device. The target entity is presented via a legacy inter-application service that is different from a service associated with a target autonomous consumer electronics device. User composition of data targeted to the target entity is facilitated via a selected one of the applications. Selection of the target entity as a recipient of a user action via the selected application is also facilitated. In response to the user action, the data is sent via a network to the autonomous consumer electronics device to cause the service of the autonomous consumer electronics device to respond to the data.

### FIELD OF THE INVENTION

This invention relates to interaction with autonomous consumer electronics devices via legacy inter-application services.

### BACKGROUND OF THE INVENTION

Mobile communications devices such as smart phones, personal digital assistants, increasingly include advanced data processing and communications capabilities. Far from being simple voice communications tools, modern mobile devices may include many different capabilities, such as email, text messaging, Web browsing, digital photography, sound recording/playback, location awareness, etc. As such, these devices are gaining ever-wider acceptance and are become increasingly valuable to end-users.

An end-user may typically own a wide range of such personal devices, and these devices may be collectively considered an “ecosystem.” Like components in a natural ecosystem, a collection of user devices may beneficially interact with each other for specific purposes for which the devices are specially adapted. A successfully formed personal device ecosystem can provide user greater benefits than can be realized with one single device, or with multiple devices that cannot interact.

Existing solutions for interconnecting mobile devices with other personal devices (e.g., personal computer, smart appliances, set-top boxes, referred to collectively hereinbelow as “target” devices) typically require the end-users to go through a tedious and often complex process of establishing a connection to the target device and using a technology-specific user interface to interact with it.

Interacting with a large device ecosystem is currently quite a complex task. For example, an ecosystem may be composed of devices supporting different interconnection technologies (e.g., UPnP, Bluetooth, X10). Each of these interconnection technologies has a different process for setting up connections to target devices and for interacting with them. End-users need an intuitive, fast, and well-defined way of interacting with other devices when performing common tasks, but such a mechanism is unavailable at present on current mobile devices. The present disclosure is directed to these and other deficiencies in the prior art.

### SUMMARY OF THE INVENTION

To overcome limitations in the prior art described above, and to overcome other limitations that will become apparent upon reading and understanding the present specification, the present invention discloses a system, apparatus and method for interacting with autonomous consumer electronics devices. In accordance with one embodiment of the invention, a mobile apparatus includes at least one network interface and a processor coupled to the network interface. Memory is coupled to the processor and includes instructions that cause the processor to represent an external, network-coupled, autonomous consumer electronics device as a target entity that is commonly accessible by applications of the mobile apparatus. The target entity is presented via a legacy inter-application service that is different from a service associated with the autonomous consumer electronics device. The instructions cause the processor to facilitate user composition of data targeted to the target entity via a selected one of the applications, and select the target entity as a recipient of a user action via the selected application. In response to the user action, the processor sends the data to the autonomous device via the network interface to cause the service of the autonomous consumer electronics device to respond to the data.

In more particular embodiments of the mobile apparatus, the legacy inter-application service includes a contact manager application of the mobile apparatus, and the target entity includes a device contact record that represents the autonomous consumer electronics device as a human contact. In such a case, the selected application may include a person-to-person communication application, and the data may include a message of the person-to-person communication application. Further in this case, facilitating user composition of the data may involve accessing a stored message template that is tailored for the autonomous consumer electronics device. In another arrangement, the instructions further cause the processor to determine, via the network, presence data associated with the autonomous consumer electronics device that describes a present ability of the autonomous consumer electronics device to communicate, and modify representation of the device contact record based on the presence data.

In other more particular embodiments, the data sent to the autonomous consumer electronics device controls the autonomous device. In another case, the autonomous consumer electronics device is coupled to an ad-hoc, peer-to-peer network. In such a case, the instructions further cause the processor to configure the target entity via the legacy inter-application service based on a service discovery record received at the apparatus via the ad-hoc, peer-to-peer network.

In another embodiment of the invention, a method involves representing, on a mobile device, a target entity that is commonly accessible by applications of the mobile device. The target entity is presented via a legacy inter-application service that is different from a service associated with a target autonomous consumer electronics device. User composition of data targeted to the target entity is facilitated via a selected one of the applications. Selection of the target entity as a recipient of a user action via the selected application is also facilitated. In response to the user action, the data is sent via a network to the autonomous consumer electronics device to cause the service of the autonomous consumer electronics device to respond to the data.

In more particular embodiments of the method, the legacy inter-application service includes a contact manager application of the mobile device, and the target entity includes a device contact record that represents the autonomous consumer electronics device as a human contact. In such a case, the method may further involve: displaying the device contact record together with human contact records in the contact manager application; determining, via the network, presence data associated with the autonomous device that describes a present ability of the autonomous device to communicate; and modifying display of the device contact record based on the presence data. In another scenario of this case, the selected application may include a person-to-person communication application, and the data may include a message of the person-to-person communication application. As such, the method may further involve parsing the message at the autonomous user device; forming a response message at the autonomous user device based on the parsed message and based on a status of the response of the autonomous consumer electronics device to the message; and sending the response message to the person-to-person communication application of the mobile device. In yet another scenario, the selected application may include a person-to-person communication application, and facilitating user composition of the data involves accessing a stored message template that is tailored for the autonomous consumer electronics device.

In another embodiment of the invention, an apparatus includes an integrated control circuit and an interworking agent coupled to the control circuit. The interworking agent includes a network interface and is configured to autonomously receive user-composed data targeted to the apparatus via the network interface. The data originates from a legacy inter-application service of a mobile device, and the legacy inter-application service is different from a service associated with the integrated control circuit. The message is composed using a device contact record that represents the apparatus as a human contact. The interworking agent parses the data and controls an operation of the apparatus via the control circuit in response to the parsing of the data in accordance with the service associated with the integrated control circuit.

In more particular embodiments, the interworking agent may be further configured to determine a presence status of the apparatus and communicate the presence status via the network for use by the mobile device. The data may include a message of a person-to-person communication application of the mobile device. In such a case, the interworking agent may be further configured to: form a response to the message based on the parsed message and based on a status of the operation performed in response to the message; and send the response to the person-to-person communication application of the mobile device. In another variation in such a case, the interworking agent may be further configured to receive contact records of the mobile device via the legacy inter-application service. In such a variation, the contact records of the mobile device may include a second device contact record that represents a second apparatus as a second human contact, and the interworking agent may thereby be further configured to communicate with the second apparatus using the second device contact record.

In another embodiment of the invention, a system includes a mobile device and an autonomous consumer electronics device capable of being coupled via a network. The mobile device includes means for representing the autonomous consumer electronics device as a target entity that is commonly accessible by applications of the mobile device. The target entity is presented via a legacy inter-application service that is different from a service associated with the autonomous consumer electronics device. The mobile device further includes: means for facilitating user-composition of data targeted to the target entity via a selected one of the applications; means for selecting the target entity as a recipient of a user action via the selected application; and means for sending the data to the autonomous device via the network in response to the user selection. The autonomous consumer device of this system includes: means for receiving the user-composed data targeted via the network; and means for controlling an operation of the service of associated with the autonomous consumer electronics device in response to the data.

In more particular embodiments of the system, the system also includes a presence data producer. The presence data producer includes: means for receiving presence data from the autonomous consumer device that describes a present ability of the autonomous device to communicate; and means for communicating the presence data to the mobile device. In such a case, the mobile device further includes means for modifying the representation of the target entity based on the presence data.

In other more particular embodiments of the system, the network includes a public network and a private network. In such a case, the mobile device is coupled to the public network and the autonomous device is coupled to the private network. The system in this case further includes an inter-device communications facility that facilitates communications between the mobile device and the autonomous device using multiple protocols.

These and various other advantages and features of novelty are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWING

The invention is described in connection with the embodiments illustrated in the following diagrams.

FIGS. 1A-B are block diagrams illustrating systems according to embodiments of the invention;

FIGS. 2-4 are block diagrams showing use case scenarios for systems according to various embodiments of the invention;

FIG. 5 is a block diagrams illustrating a mobile client implementation according to embodiments of the invention;

FIG. 6 is a block diagram showing system functional components according to an embodiment of the invention; and

FIG. 7 is a flowchart showing a procedure according to embodiments of the invention.

### DETAILED DESCRIPTION OF EMBODIMENTS OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present disclosure is directed to enabling end-users to interact with a personal device ecosystem via a mobile device in the same way as they interact with the “ecosystem” of people and friends they know in the real life. The solution is based on deep integration of personal devices into traditional smart-phone and/or PDA user interface (UI) idioms and built-in applications. In such a system, devices in the ecosystem can interact automatically using (or extending) built-in capabilities with which the users are already familiar. For example, a user may wish to view on their television (TV) a photo that was taken on a mobile phone. On existing systems, this might involve transferring the photo data to a portable memory device using a bus interface, and then transferring the data from the portable memory device to the TV. Alternatively, the user may transfer the photo data via a network to an intermediary device (e.g., personal computer) that is hooked up to the TV. In either case, there is an intermediary step of transferring data files. This intermediary step may require knowledge of local/network file transfer mechanisms, file system hierarchies, device specific menus, etc. As such, using a file transfer to display the picture may involve operations that are too cumbersome or difficult for all but the most knowledgeable users.

Another way to allow the user to automatically view the photo on the TV is for the TV manufacturer to provide a custom client-side program that allows the picture to be selected from the mobile device and viewed on the TV in one step. The disadvantage to this approach is that it may be complicated and expensive for a TV vendor to write such software. There are a wide variety of target devices platforms and models, and each platform may need a special version ported to the platform (e.g., compiled specifically for the processor and operating system of the platform). Testing such software would also be difficult, because it may require testing for both different platforms and different device models within a platform. Another disadvantage to this approach is that the user would have to learn a new piece of client software, which they rarely want to do.

However, it will be appreciated that modern mobile devices may have existing common legacy services for performing inter-application actions with photographic data. An example of such a legacy service is a printing service. The device may already be easily configured to discover a new printer and send a photo to the printer with a single click. Therefore, in a system according to an embodiment of the invention, the TV could be modeled on the mobile device as a printer, and the user merely needs to “print” the photo to the TV, where it shows up. In such a case, the user can use a familiar interface with which they are already experienced, and the user need not be aware of any underlying file transfers and data conversions involved in such uses.

Another example of how these interactions between personal devices may be implemented involves controlling an autonomous device by sending messages using legacy, person-to-person communications to the autonomous device. For example, the user may be well familiar with a text messaging application on his or her mobile device. The mobile device may be configured to automatically add the TV as a contact to the mobile device. Such a “TV contact” may be added via a contact manager utility that is commonly accessible by many applications of the device. When the user wishes to control the TV in this case, they can send a message such as “Off,” “On,” “Mute,” etc. to the “TV contact” just as if the TV was a person. The TV can receive, parse, and respond to the messages accordingly. Or, if the user feels more comfortable doing the same task using an email program on the client, the “TV contact” would also be available to the email program. Thus the user could alternatively use the email program to perform the same task without any additional work.

Thus, even though an autonomous device such as the TV may be capable of direct user interaction (e.g., buttons, switches, infrared remote control), the device may also advantageously contain a feature (e.g., electronic logic) that allows it to operate autonomously to at least asynchronously act on other data from a network without direct user input. Specially crafted software could link these automation features with a legacy inter-application service of a mobile device. In particular, the autonomous device may be modeled by this inter-application service in a way that is not normally associated with that device. For example, most users would not normally consider a TV as a printer or as a human contact. However, when the TV is presented as such, the actions taken to interact with the TV are intuitive because of the user's previous experience using printers and person-to-person communication programs.

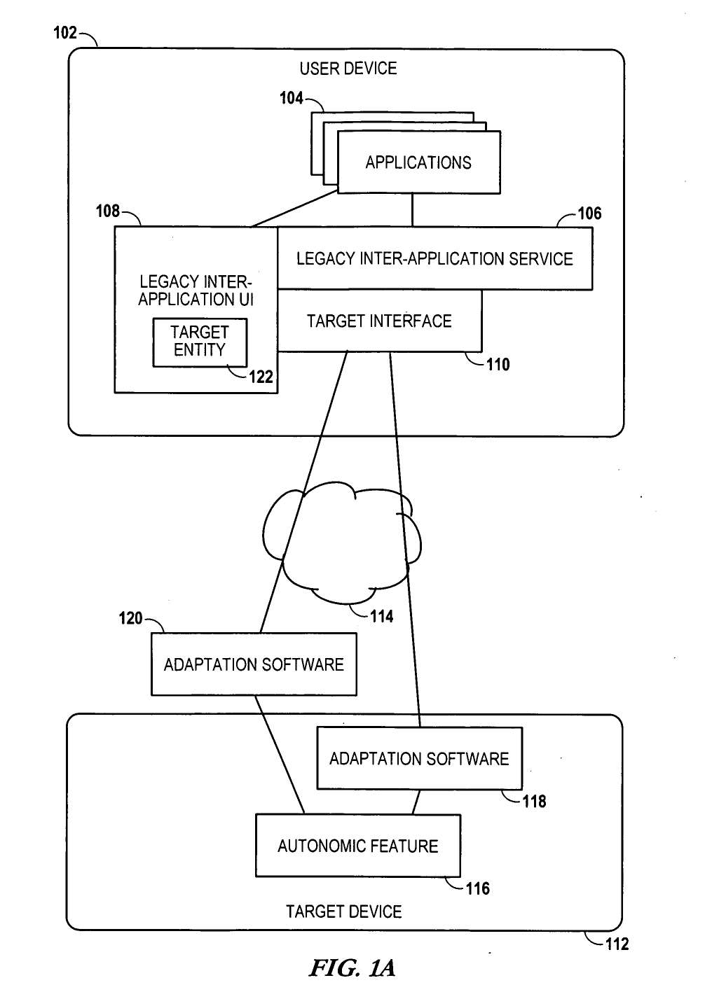

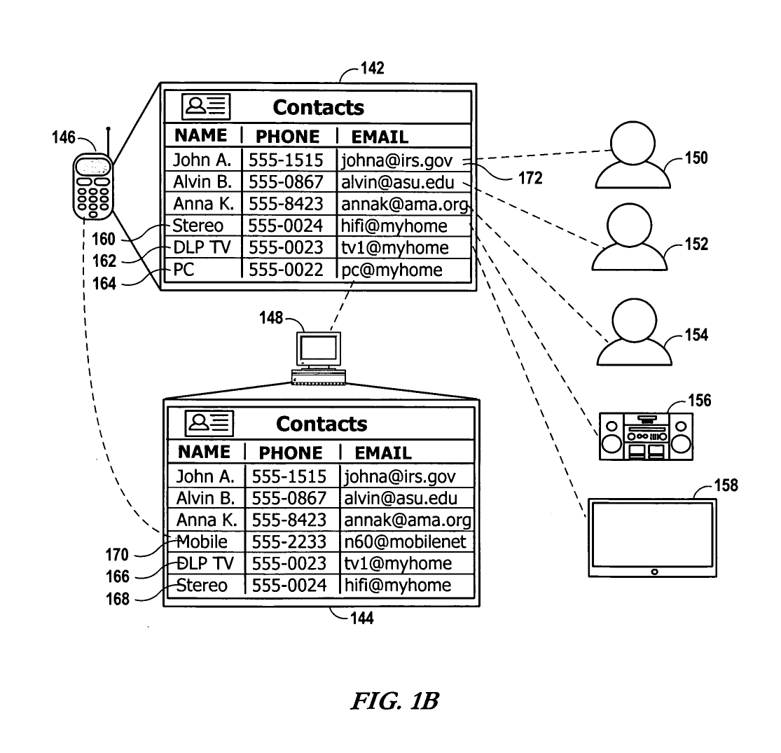

In FIG. 1A, a block diagram illustrates an example system according to an embodiment of the invention. A user device 102 includes one or more applications 104. The applications 104 may include any user programs known in the art, such as person-to-person communications (e.g., text messaging, telephony, email, etc.), productivity (e.g., word processing, spreadsheet, calculator, graphics composition, document readers), sensor capture (e.g., photography, sound recording, telemetry, biometrics), entertainment (e.g., media playback, games, network content browsing), and system utilities (e.g., command line interfaces, control panels, system monitor, system configuration).

The applications 104 generally interact with a commonly accessible legacy inter-application service 106. The service 106 may be any combination of hardware service, operating system feature, third-party feature, commonly accessible data structure, etc. The service 106 is “legacy” at least in that the service has an established purpose such as hardware access/configuration, contacts management, printing, network access, file system access, system registry, inter-application messaging and data conversion, etc. The service 106 may be “inter-application” in at least that it is commonly accessible by any number of the applications 104, and the service 106 may further facilitate transfer of data between two or more applications 104. An example of the latter is an operating system cut-and-paste application program interface (API) and/or file system access/status API. The legacy inter-application service 106 may also have a common user interface (UI) 108. For example, operating systems may include a printer access UI that is integrated with a file system display, control panel interface, and/or system API that presents common and uniform printing menus and dialogs.

In the illustrated system, a target interface module 110 extends the legacy inter-application service 106 to interact with a target device 112 via a network 114. Target device 112 is generally a special purpose consumer electronics device that includes autonomic features 116 (e.g., control circuitry) that may be accessed without physical contact by a user or device. Although autonomic features 116 are commonly associated with remote control uses, such feature 116 need not be limited to such uses. Generally, additional circuitry and/or software may be used to extend the functionality of the features 116, as represented by example internal and external adaptation software modules 118, 120. As will be appreciated from the illustration, the adaptation software 118, 120 may be part of the target device 112 and/or an external component. The adaptation software 118, 120 may work independently (e.g., only one of the modules 118, 120 is needed for operation) or interdependently (e.g., 118, 120 modules work in concert with each other).

The adaptation software 118, 120 may allow the feature 116 of the target device 112 to be accessed by applications 104 of the target device by way of the inter-application service 106. The applications 104 and/or legacy inter-application UI 108 may present the feature 116 as a target entity 122 that can be operated in the conventional manners dictated by the legacy inter-application service 106. However, the target feature 116 is different than those entities normally dealt with by the service 106. As was described above, one example of this mapping is where a target feature 116 includes a temporary display on a TV, and the inter-application service 106 is a printing service of device 102. The “printing” of an image to the TV does not result in a persistent image being created as is normally associated with printing. An analogous example is where the TV is represented as a file folder on the device 102. An image dragged to this folder may appear as a file on the system, but does not have other attributes of computer files (e.g., persistence, being opened viewed by any application). Some behaviors in such a case may be different than expected by the service 106. In the file folder example, dragging a second image to the TV folder may cause the previous image “file” to disappear. Such differing behaviors could be troubling for the user, except that when the user sees the images change on the TV, the reason for such behavior may become apparent.

A useful inter-application service available in many devices (particularly mobile devices) is a contact manager application that allows contacts to be stored on the device and used by other applications to engage in person-to-person communications. In reference now to FIG. 1B, a block diagram illustrates a system according to an embodiment of the invention. In this system, modified legacy inter-application services are shown as contact management programs 142, 144 operating on respective mobile and fixed computing devices 146. The contact management programs 142, 144 are general-purpose contact management user programs that are integrated into respective devices 146, 148. The integration of contact management functionality in devices 144, 146 may be accomplished by any combination of an operating system feature, add-on system utility, application suite, or some other commonly accessible program that deals with managing human contacts. The contact management programs 142, 144 generally include a user interface as shown, and also generally include data, background functions, and services that are not necessarily presented to the users.

Generally, contact management programs 142, 144 allow users to add, modify, remove, and otherwise manage human contact data. This contact data generally includes data describing the person (e.g., name, business name) and data describing how the person may be contacted (e.g., mailing address, email address, phone numbers, etc.). Various types of contact data stored on devices 146, 148 is associated with a particular person or group of persons, as represented by human contacts 150, 152, and 154. The purpose, use, and operation of contacts managers 142, 144 and the like are well known to many computer users. In particular, contacts management has historically been an important feature of mobile computing devices 146, because such as devices 146 can be kept readily available for whenever contact data may be needed.

The devices 146, 148 according to embodiments of the invention include special adaptations that allow the contact management programs 142, 144 to represent personal ecosystem devices (e.g., mobile device 146, computer 148, audio system 156, and television 158). The audio system 156, television 158, and computer 148 are shown in program 142 as respective contact records 160, 162, 164. Program 144 includes records 166 and 168 that represent, respectively, the television 158 and audio system 156, as well as record 170 that represents mobile device 146.

The device contact records 160, 162, 164, 166, 168, 170 (e.g., “friend devices”) may have the same appearance and behavior in the device user interface as human contact records (e.g., contact record 172 associated with person 150). It will be appreciated that a personal contact record 172 includes data that is ultimately used to access a human being, however there is no such expectation with a “friend device” records 160, 162, 164, 166, 168, 170. Nonetheless, the target devices 146, 148, 156, 158 may be configured to engage in relatively non-structured communications with the programs 142, 144 as if a human was receiving the message and responding in kind. Further, the target devices 146, 148, 156, 158 may engage in these communications using existing protocols and mediums that may have been originally developed for person-to-person communications, such as telephone, text messaging, and email. Event though the user engages in a simulated conversation with a device, the user will recognize that the ultimate goal of such communications is not personal communications, but a target device function such as remote control or display of content (e.g., text).

In order to communicate with a consumer device such as television 158 using a contacts management program 142, 144, the target device 158 may require special adaptations. A device such as television 158 is traditionally controlled by way of a device-mounted controls and/or a device-specific wireless remote control, these devices are increasingly including general purpose computing features. For example, consumer entertainment devices often include microprocessors, and increasingly have capabilities such as the ability to upgrade firmware, communicate over computer networks, store additional program or content data on non-volatile media, etc. In such a case, the device 158 may be adapted to receive an electronic message sent by way of the contact management programs 142, 144. This electronic message may include any combination of email, Short Messaging Service (SMS), Multimedia Messaging Service (MMS), voice message, presence/Instant Messaging (IM), etc. The device 158 can be adapted to interpret and respond appropriately to these messages. In this way, a user can interact with devices in the personal ecosystem in the same way they interact with human contacts, thereby simplifying access to these devices.

In various embodiments of the invention, a special group of “contacts” associated with devices can be defined within the mobile device platform (e.g. a Friend Devices list). In this way, users can access the devices from the phonebook by sending them messages, calling them (voice/video call), or engaging in some other person-to-person-type communication. End-users can send the messages via one device (typically a portable device such as a PDA or a smart-phone) to other devices belonging to reachable “smart spaces” in order to control the target devices. For example, the user could send an “On” message to a washing machine or send a calendar entry to a VCR in order to program it for recording an important sport event. Similarly, the target devices may autonomously send messages to the end-user in order to notify important events. For example, a home alarm system could send a text message to a user's mobile device based on some monitoring event occurring (e.g., door opened, doorbell rung). In order to facilitate this type of communication, the autonomous device may maintain and use its own contacts list, similar to the way the user might on a personal device.

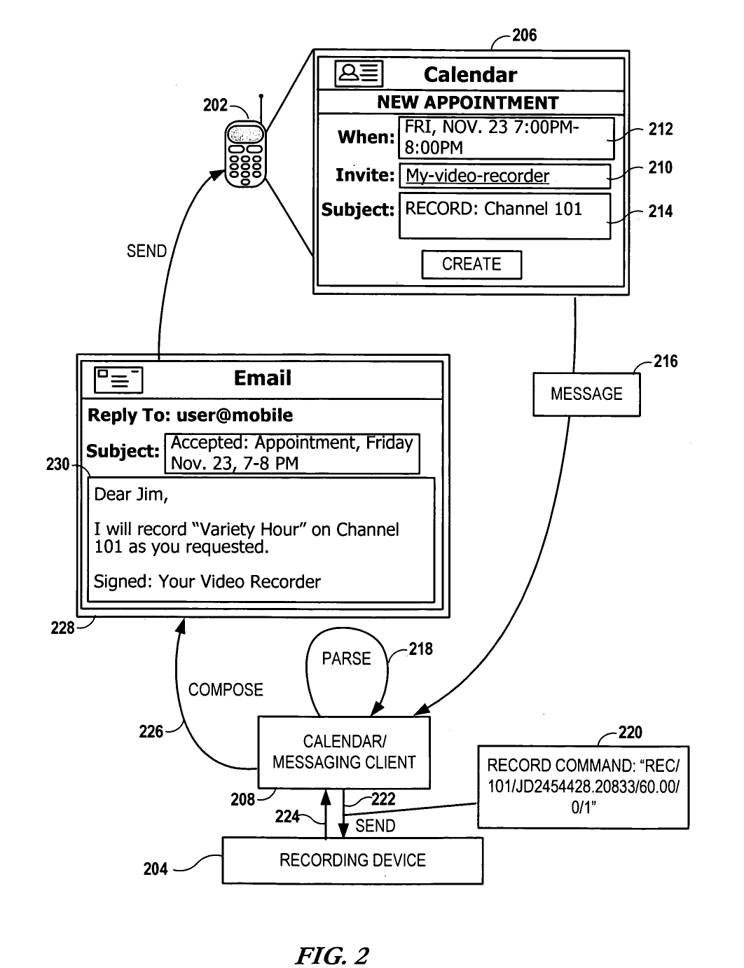

Additional example embodiments of the invention are now discussed in relation to FIGS. 2-4. In FIG. 2, a block diagram shows a use case scenario involving a mobile device 202 being used to program a media recording device 204 according to an embodiment of the invention. The mobile device 202 may be any portable apparatus capable of running a calendar and messaging application (or any other mobile device application), such application being represented by UI screen 206. The calendar application 206 may be a general purpose program that enables users to schedule appointments, reminds the users of those appointments, and sends invite messages to devices of other users so that those other users can automatically add the invitations to their own local calendar application. The mobile device 202 includes an underlying device framework that allows the media recording device 204 to be modeled the same as a human contact. In this case, the recording device 204 can be invited to a “meeting” the same as a human contact, albeit possibly for different purposes than if the invitation was directed to a person.

The recording device 204 may be any device capable of timed capture of media, such as a videocassette recorder (VCR), digital video recorder (DVR), web camera, audio recorder, sensor, etc. The recording device 204 communicates with a calendar/messaging client 208 that is compatible with general purpose calendar and messaging applications such as terminal application 206. The calendar/messaging client 208 may be integrated within the recording device 204, or be implemented as add-on, peripheral, and/or external device that communicates with the recording device 204 using a native protocol. For example, the calendar/messaging client 208 may be implemented in a computing device with an infrared transmitter, and the client 208 communicates with the recording device 204 via an infrared remote control interface.

In the scenario illustrated in FIG. 2, a user can use the calendar application 206 to remotely program the recording device 204 for purposes such as recording a particular show. The user's mobile device 202 includes a special home device contact entry as represented by contact entry 210. The contact 210 may refer to a particular email address, telephone number, mobile subscriber integrated services digital network number (MSISDN), international mobile subscriber identity (IMSI), or other unique identifier usable to electronically communicate with the calendaring/messaging client 208. The invention does not depend on any particular messaging identifier be associated with the target device 204 and/or client 208, nor is it necessary that the user know such identifier. As will be explained in greater detail below, the contact entry 210 may be automatically provisioned to the mobile device 202 so that the user merely has to invoke the provisioning and see that the contact 210 has been added to the contacts database with a useful identifier (e.g., “My-video-recorder”).

Other data of interest in programming the recording device 204 may include the time and channel (if applicable) of the recorded event. The time function is already integrated into the calendaring application, as represented by appointment time 212. Other data may be communicated to the target device by way of a subject line 214 and or message body portion (not shown). In this example, the subject line 214 includes a command to record a particular channel using a fairly easy to remember grammar. The implementation of the commands can be flexible, and the client 208 may be able to parse and understand natural language commands to some extent. Other data that might also be included in the subject line 214 (or other text entry portion) may include setting recording priority, indicating whether or not a confirmation reply is needed, a label used to identify the recording, etc.

The commands entered by way of the example subject line 214 may be entered using free text input, and the application 206 may help guide the user in forming a properly formatted message. For example, the application 206 may include templates that can be selected by the user whenever a particular recipient 210 is selected. Such a template may appear as an editable form with user interface components (e.g., a check box to select a particular command) and blank input fields (e.g., “RECORD: Channel _”) so that the user only need enter the minimal information needed to form the desired command.

Once the appointment data is complete, a message 216 is sent to the target device 204, which in this case is received via the calendaring/messaging client 208. This message 216 may be sent by any combination of appropriate messaging networks, formats, and protocols, such as SMS, email, MMS, IM, SIP signaling, etc. The message 216 may contain the appointment data 210, 212, 214 in a proprietary format specific to application 206 and client 208, and/or the appointment data may be sent in an open format, such as by use of an eXtensible Markup Language (XML) document.

The calendaring/messaging client 208 is configured to receive and parse 218 the message 216. After parsing 218, the calendaring/messaging client 208 may be able to form a device-specific command 220 that is particular to the recording device 204. In this example, the device-specific command 220 is a delimited text string, although it will be appreciated that the devices may use a wide variety of formats and protocols. For example, the client 218 may be able to send a sequence of infrared remote commands that accomplish the same thing as command 220. The command 220 is sent 222 to the recording device 204 may (or may not) send an explicit acknowledgement 224 that the command 220 was successful.

Whether or not the client 208 can determine that the command 220 was successful, the client 208 may still be configured to compose 226 a response message, here in the form of an email 228. It will be appreciated that the type of the command message 216 and response message 228 may be of the same or different formats. However, where the formats are the same, the messages 216, 228 can be configured so as to resemble a dialog with another person. For example the example response message 228 includes confirmation text 230 that is written in conversational language. Such a conversational response message 228 may be particularly useful when there is a problem. For example, the message could state “Sorry, there is another program, Show B, scheduled to be recorded at that time. Would you like to cancel recording of Show B? If not, then no need to respond.”

It will be appreciated that there are a number of advantages in commanding the target device 204 using a contact management facility of the mobile device 202 as opposed to a custom control program. For example, less technically sophisticated users are usually familiar with the conventions of basic productivity and communications applications, therefore such users will be more likely to embrace a new capability (e.g., remote control of home devices) if that capability does not involve the learning of new software. Also, the ubiquity of common formats such as email and SMS means that the remote control functions can be realized using a wide variety of different user programs, such as application 206 and equivalents thereof. Therefore such a system can be implemented in a heterogeneous software and hardware environment. Similarly, the protocols underlying these existing person-to-person communications are reliable and well known, and therefore can be implemented with little or no change to infrastructure.

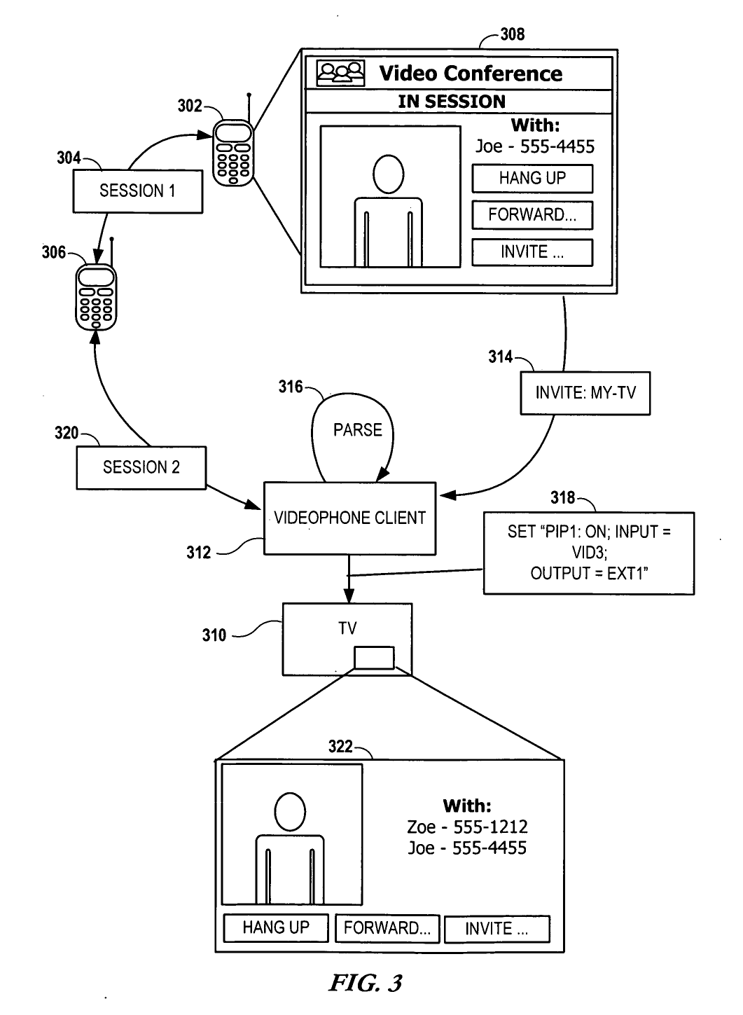

In reference now to FIG. 3, a block diagram illustrates another use case scenario according to an embodiment of the invention related to streaming and rendering of media to an autonomous consumer electronics device. In this example, user Zoe is using mobile device 302 for a video call session 304 with device 306 of Joe. Zoe's mobile device 302 is using application 308 for the conference call. Zoe may wish to continue the session via 304 television 310 instead of using device 302. In this example, the TV 310 includes a videophone client 312 that may be included in the TV 310 and/or may be peripheral to the TV 310. Zoe's mobile device includes a contact record (not shown) for reaching the videophone client 312. The client 312 can be used to have the TV 310 take part in a session with one or both of terminal devices 302, 306.

In this example, the application 308 sends an invitation 314 to the client 312 to join the session 304. The client 312 need not have any rendering capabilities, but will generally be aware of the rendering capabilities of the TV 310. The client 312 may perform session initiation actions in response to parsing 316 the invitation 314, and thereby establish a session 320 with one or more of terminals 302, 306. In response to parsing 316 the invitation 314, the client 312 may also send a command 318 to the TV 310. In this case, the command 318 sets a picture-in-picture (PIP) frame to a particular input and output channel where the videophone client 312 will send the decoded streaming data of the session. As can be seen in the example TV UI 322, the client 312 may provide its own video client that can control or change various aspects of the ongoing session.

After the TV session 320 has been established, Zoe may hang up the phone and use the TV 322 for one or both of audio and video conversation. In another scenario, the TV 310 may include or be replaced with a recording device (e.g., VCR, DVR) so that Zoe can record the call. By utilizing the built in conferencing capabilities of the session protocols and the application 308, the a device contact can conveniently enable end-users to stream media contents to locally situated or remote devices without having to operate a UI that is specifically adapted for the remote devices.

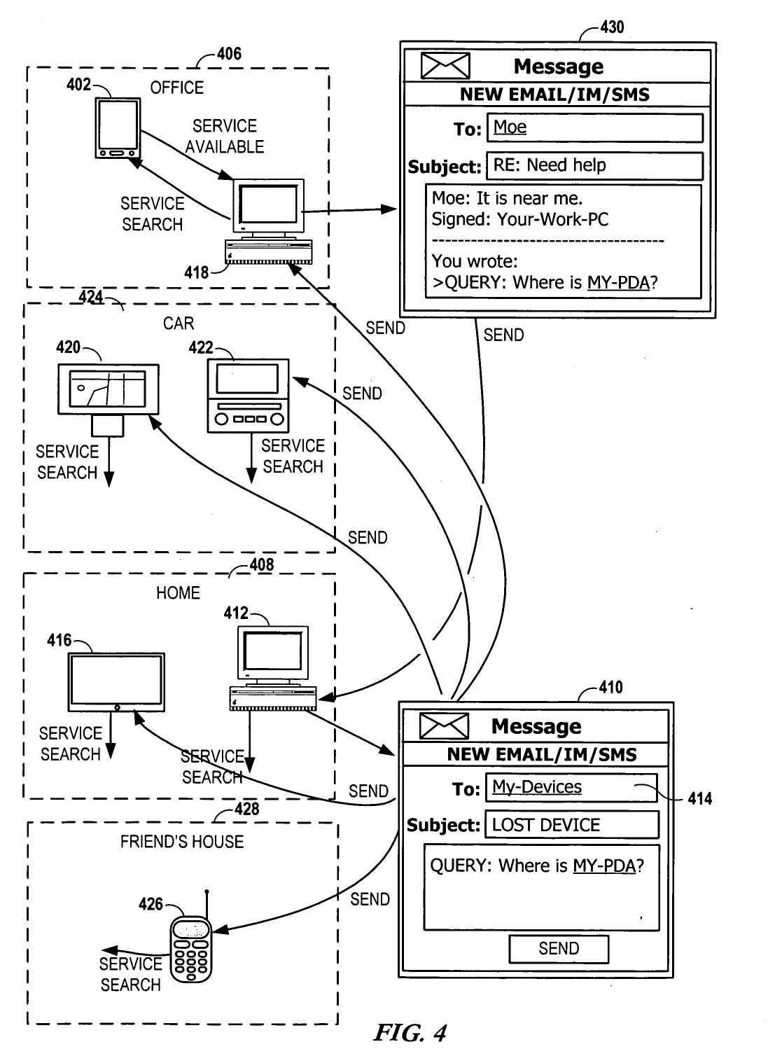

In reference now to FIG. 4, a block diagram illustrates another use case according to an embodiment of the invention. In this case, the scenario relates to detecting the location of a lost personal device. The user in this scenario has left a PDA 402 in his office 406, but has forgotten about it. When the user is at home 408, he believes he might have lost the PDA 402. To check where the PDA 402 might be, the user composes a message 410 from a home PC 412. The message may be composed by a particular messaging program (e.g., email, SMS) or by a generic program that can send messages via a number of suitable protocols depending on the target contact.

In this example, the message 410 is directed to a particular contact group record, as indicated by the “To:” header 414. This contact group record 414 can contain all of the devices of the user's device ecosystem, and the contact data associated with a particular device may indicate a preferred messaging protocol and format. The program used to draft the message 410 may be able to use a number of alternate sending protocols to dispatch the message to the other devices. Those other devices may include a TV 416 in the home 408, a desktop PC 418 in the office 406, a navigation system 420 and entertainment system 422 in the user's car 424, and a smart-phone 426 at a friend's home 428, where the user had visited previously that day.

Each contacted device 416, 418, 420, 422, 426 (as well as the originating device 412) tries to discover devices in its proximity. In this example, the proximity discovery may utilize wireless proximity technologies such as Bluetooth service discovery, examination of Wireless LAN (WLAN) media access control (MAC) identifiers, radio-frequency identification (RFID) tags, etc. In this example, the desktop PC 418 at the office 406 is able to discover the PDA 402 through Bluetooth service discovery. In response, the desktop PC 418 composes a response message 430 and sends the message 430 to the user, informing the user that the PDA 402 is in the office 406. The devices 412, 416, 420, 422, 426 that did not detect the PDA 402 might also send a response message saying that they did not detect the PDA 402. In this way, the user might at least be able to determine that it is less likely the PDA 402 was left in those locations 408, 424, 428.

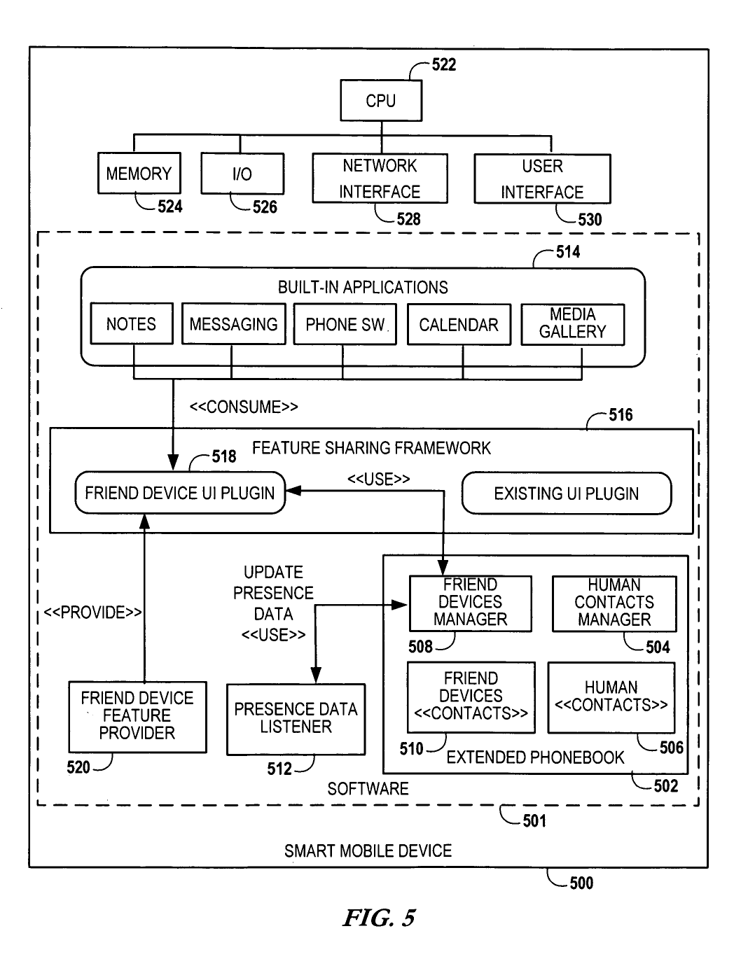

In reference now to FIG. 5, a block diagram illustrates an example implementation of a software architecture 501 for a mobile device 500 according to an embodiment of the invention. One component of this architecture is a component known as an extended phonebook 502. The extended phonebook 502 is a variant of the traditional phone book application and/or contact manager application. As such, the phonebook 502 provides a manager 504 and data 506 for managing human contacts as is known in the art. As referred to herein, the term “human contacts” refer to data used to engage in contacts where it is assumed the end recipient is a person. The human contacts data 506 may include device data (e.g., telephone number, email address) or non-device data (e.g., postal mailing address, business name).

The extended phone book 502 also transparently provides a manager 508 and data 510 used to manage “friend device” contacts, e.g., those contacts explicitly set up for automatic, conversational-type communication with a machine, in particular autonomous or semi-autonomous machines with which the user has some access and/or control privileges. The managers 504, 508 may be integrated into a single UI, such that the user can use the same paradigms, commands, behaviors, and features for accessing both human contact data 506 and device contact data 510. As such, the extended phone book 502 provides convenient control over devices using familiar user interface and behavior paradigms associated with human-to-human contact programs.

The contacts data 506, 510 captures relatively static data about respective target people and devices, and how to locate/contact those people and devices. In messaging systems known in the art, there are ways of communicating more dynamic data that describes the readiness and willingness of people to communicate, generally referred to as “presence” data. Technologies such as instant messaging (IM) utilize presence services to allow endpoints to communicate their current communication status (e.g., available, busy) to others, and allow the endpoints to discover the communication status of others.

In embodiments of the present invention, friend devices can extend known presence technologies to provide presence/availability data usable by the device 500. As such, the architecture of device 500 includes a presence data listener 512 that may determine device presence from friend device as will be described in greater detail hereinbelow. Each device in a smart-space can be assigned a presence state that is used by the system to evaluate the possibility of establishing connections to the device at run-time. Presence information may include data about current status of the device (e.g. standby, recording, alive, unreachable) as well as data about the currently available inter-device communication networks (e.g. GSM network, direct IP connection) and eventually a richer set of “context” data, including physical location and other context attributes. All these aforementioned presence attributes may be dynamic and thus may change over time based on current context.

The presence data listener 512 is in charge of updating presence information about the friend devices within a particular smart-space based on up-to-date data available through the presence infrastructure of the friend devices. The presence data listener 512 can obtain the device presence data directly or indirectly from friend devices and communicate this data to the friend device manager 508. The friend device manager 508 can use the presence data to update UI elements, modify connection modes, alert the user, etc.

The user of device 500 should preferably be able to utilize the services provided via the friend devices manager 508 (and associated components) without having to add and learn new user software. As such, the friend device features described herein may be utilized via the terminal 500 without having to make significant (or any) changes to existing communication applications, as represented by built-in applications 514. In this example, the terminal includes a feature sharing framework 516 that may be used to extend the functionality of the built-in applications 514. The feature sharing framework 516 may include any application or operating system framework that allows extending existing applications through the addition of self-contained code. This code may be variously referred to as a component, an object, a plug-in, etc.

Some programs, such as media players or web browsers, contain a specific plug-in interface for that particular program. For example, a codec may be added to a media player through the use of a plug-in. The feature sharing framework 516 may include program-specific architectures such as the plug-in interface such as used by the Mozilla Firefox browser. In other embodiments, the feature sharing framework 516 may include a general purpose extension architecture that may be implemented on any program running on the device 500. An example of a general-purpose extension architecture includes technologies such as Microsoft™ Component Object Model (COM), Common Object Request Broker (CORBA), Symbian™ OS ECOM, Java™ Beans™, etc.

In the illustrated framework 516, a friend device plug-in 518 may be used to extend the UI of one or more applications 514. This plug-in 518 may be configured to provide any functional feature allowed by the framework 516, from minor UI adjustments (e.g., denoting friend device contact with a different icon than human contacts) to major functional extensions (e.g., new message templates, embedding controls in messages, etc.). The friend device plug-in 518 can communicate directly with the friend device manager 508 to provide this capability.

The friend device UI plug-in 518 may be implemented by a component herein referred to as a friend devices feature provider 520. The feature provider 520 may be an installer and/or system component that implements the friend devices plug-in(s) 518 according to the rules of the feature sharing framework 516. The feature provider 520 may provide one time and/or on-going services related to the plug-ins 518, including file installation, modification of system data (e.g., registry entries, configuration files), update monitoring, performance tracking, conflict resolution (e.g., selection of compatible system libraries) etc. The feature provider 520, friend device plug-in 518, and friend devices manager 508 combine to provide a new set sharable features that the other on-device applications 514 can automatically add to their own features through the feature-sharing framework 516.

It will be appreciated that the mobile device 500 may be a general purpose mobile processing device. As is known in the art, such processing device 500 generally includes one or more central processing units (CPUs) 522. The CPU 522 may be coupled to any combination of memory 524, input/output bussing 526, network interfaces 528, and/or user interfaces 530. The memory 524 may include any combination of non-volatile electrically-erasable, programmable read-only memory (EEPROM), flash read-only memory (ROM), hard-drive, etc. so that the information is not lost upon power down of the mobile terminal 500. The relevant software 501 for carrying out conventional mobile terminal operations and operations in accordance with the present invention may also be transmitted to the mobile device 500 via data signals, such as being electronically downloaded via the network interface 528 from more networks, such as the Internet and an intermediate wireless network(s).

The mobile device 500 may include multiple network interfaces 528 for maintaining any combination of wired or wireless data connections. A wireless network interface 528 may include wireless network circuitry such as a digital signal processor (DSP) employed to perform a variety of functions, including analog-to-digital (A/D) conversion, digital-to-analog (D/A) conversion, speech coding/decoding, encryption/decryption, error detection and correction, bit stream translation, filtering, etc. A transceiver (not shown) of the wireless network interface 528 transmits outgoing radio signals and receives the incoming radio signals associated with the device 500. The network interface 528 may be compatible any voice and data communications infrastructure known in the art, including CDMA, W-CDMA, GSM, EDGE, etc. A network interface 528 may also be capable of accessing via I/O and network technologies such as USB, Bluetooth, Ethernet, 802.11 Wi-Fi, IRDA, etc.

The CPU 522 is also coupled to user-interface elements 530 associated with the mobile device 500. The user-interface 530 may include, for example, a display such as a liquid crystal display. Other user-interface mechanisms may be included in the interface 530, such as keypads, speakers, microphones, voice commands, switches, touch pad/screen, graphical user interface using a pointing device, trackball, joystick, etc. The device 500 may also include integrated or peripheral sensors, which may detect certain environmental conditions such as location, acceleration, temperature, light, etc.

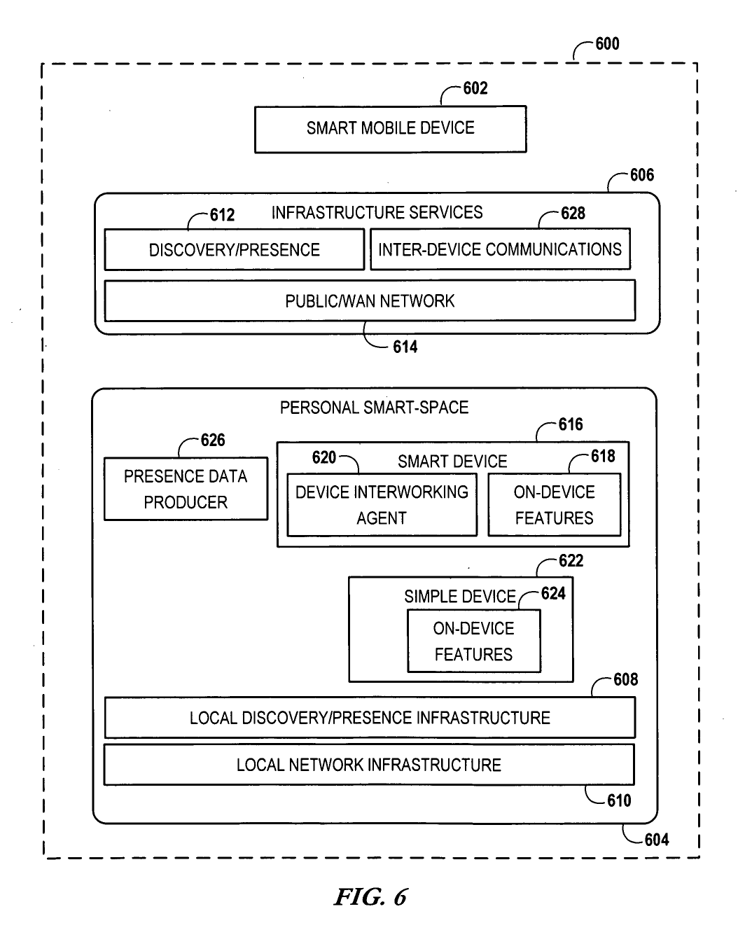

In reference now to FIG. 6, a block diagram illustrates additional details of a system framework 600 according to an embodiment of the invention. Generally, a smart mobile device 602 may include any combination of features such as described in relation to mobile device 500 in FIG. 5. The mobile device 602 may communicate with personal smart space 604 either remotely (e.g., via a public infrastructure 606) or locally, via local discovery/presence infrastructure 608 and local network infrastructure 610. In many cases, the available services may be different depending on whether the mobile device 602 is operating in the local smart space 604 or remotely via the public infrastructure 606. For example, the public infrastructure 606 may contain discovery/presence infrastructure 612 of its own. However, for reasons such as security and scalability, the availability, configuration, and protocols of the publicly accessible infrastructure 612 may be different than analogous private discovery/presence infrastructure 608.

For purposes of the present invention, it may be assumed that the mobile device 602 can operate within the personal smart-space 604 whether locally situated or connected to the outside infrastructure 606. For example, the smart space 604 may include a device, such as a multi-protocol, inter-device communication facility 628. This facility 628 may couple the public discovery/presence infrastructure 612 with the local discovery/presence infrastructure 608. These infrastructures 612, 608 may be coupled via the facility 628 analogously to a gateway that may couple the local network 610 to a public network 614. However, the inter-device communication facility 628 may also translate between data and protocols used by the different infrastructures 612, 608.

Each device in the smart-space 604 from the public networks 614 might be accessible by using the inter-device communication facilities 628. For example, one device such as a set-top box could be connected to a broadband WAN and to a fixed telephone network at the same-time, thus being able to be contacted by using telephone or IP/internet connection. Although the inter-device communication facility 628, is shown outside the personal smart space 604, it will be appreciated that the facility 628 may be simultaneously coupled to both external and internal spaces 606, 604, similar to a gateway, bridge, router, or the like.

The personal smart space 604 may include at least one smart device 616. This device 616 may be a device that is not traditionally considered to be a computer (e.g., appliance, home entertainment device) but is adaptable for computer communication. The smart device 616 may have integrated computing hardware (e.g., components such as CPU, memory, peripheral busses, network interfaces) or be adapted to interface with external computing hardware. This computing hardware may be part of integral on-device features 618 and/or a device interworking agent 620. Computing hardware may also be added peripherally to the device 616. For example, the device interworking agent 620 may be configured as a peripheral processing device that electronically or physically interacts with the control circuitry of the device 616 and/or its operating features 618.

The on-device features 618 generally include conventional control circuitry that may be activated by way of manual controls or proprietary remote controls. The device interworking agent 620 allows the device 616 to be controlled by a person-to-person messaging application of the mobile device 602 in an autonomous fashion. The device interworking agent 620 may be perform such tasks as parsing incoming messages/calls, and executing tasks on the smart device 616 based on the received requests. Such tasks may include remote device control, composition of on-device features, dynamic downloading, deployment, execution of new components on the device 616, etc. The device interworking agent 620 may be flexibly configured to receive different types of commands using a variety of messaging formats and protocols. The agent 620 may execute some tasks based on message contents, on the type of requested command (e.g. video call or voice call), or other criteria. The agent 620 may also be able to initiate communications (e.g., send alerts to users) and communicate with other devices using the person-to-person messaging protocols.

The personal smart space 604 may also include one or more “simple” devices 622. These devices 622 may not be capable of running a device interworking agent. Such devices 622 may still be accessed and invoked by using exclusively on-device features 624. For example, a mobile phone could accept video and phone calls, whereas a TV-top box could offer a web-based interface for administration and usage.

The smart devices 616 and simple devices 622 in the local smart space (or ecosystem) may be very different one from each other. Smart devices 616 can be extended and personalized by adding new pieces of software. For example, a smart device 616 may provide a wide variety of networking capabilities (e.g., 2G/3G networks, USB, Wireless LAN, Bluetooth). Simple devices 622 are generally not as extensible as the smart ones, and these devices 622 typically provide fewer features and options. Nonetheless, the system 600 can be adapted to include at least assume two different macro sets of devices to be available, namely smart devices 616 and simple devices 622.

Certain system adaptations can be made to allow these devices 616, 622 to interoperate with each other, as well as operating with mobile device 602. For example, smart device 616 may include an infrared transmitter that is usable to send commands to simple device 622 based on received messages from the device interworking agent 620. This transaction could be modeled as though the simple device 622 had an interworking agent (e.g., the interworking agent 620 may include a proxy agent for simple device 622), although with some limitations. For example, where the smart device 616 controls the simple device 622 via infrared remote controls, the smart device 616 can send the commands, but it may not be possible for the smart device 616 to determine that the commands were successfully executed by the simple device 622, as the simple device 622 may have no way of externally communicating its state.

As with the smart device 616, the simple device 622 may include its own on-device features 624. Generally, each device in the ecosystem 604 may be characterized by a set of standard features that it is capable of performing. For example, a phone device is typically capable of accepting (or initiating) phone (video or voice) calls to (from) another phone as well as of sending text and multimedia messages to other devices. The on-device features 618 of a smart device 616 are typically larger and more dynamic than the corresponding features 624 of a simple device 622.

As was previously described in relation to FIG. 5, the mobile device 602 may utilize a presence listener for determining presence data from the local smart space ecosystem 604. To provide this presence data, the ecosystem 604 may include one or more presence data producers 626. The presence data producer 626 is configured to generate presence information about the devices within a single smart-space 604 and publishing the presence data to one or more of the local presence infrastructure 608 or remote presence infrastructure 612.

Although presence data is usually tied to more immediate forms of communications such as phone calls and instant messaging, the presence data producer 604 may provide presence data of interest for any device regardless of the actual communication technology. For example, if a device interworking agent 620 uses email exclusively for receiving communications, the user may still be interested in such emails being processed in a timely manner when sent as a command from the mobile device 602. As such, the use of presence data provided from the producer 626 can assist the mobile device user in knowing that the target device is currently available, and a change in presence data related to the target device may be useful in determining that the command was successful.

The dynamic device discovery and presence infrastructure 608 may be useful in providing a standardized way for the presence data producer 626 to determine and report presence data throughout the smart space 604. The service discovery part of this infrastructure may also include service discovery functions such as provided by peer-to-peer ad-hoc networking protocols such as UPnP and Bluetooth. Among other things, the service discovery infrastructure 608 enables devices in the ecosystem 604 to discover other active devices along with services running on them.

Although extending the concept of “personal contacts” to cover autonomous device is particularly useful when applied to the domain of user programs on the mobile device 602, this concept can also be extended to device-to-device communications. For example, the device services provided by the service discovery infrastructure 608 may be modeled as contacts reachable by person-to-person communications services in the same way that these services are presented to the user in the mobile device 602. In such a case, each compatible device (e.g., device 616) in the ecosystem 604 may include a contacts manager and list of contacts, and these lists may include both human and non-human contact records. The human contacts may at least include the user of the mobile device 602, and include such data as name, phone number, and email address.

New features may be dynamically integrated within the mobile device 602 and devices of the smart space 604 using the service discovery infrastructure 608. In some configurations, the system 600 may be configured to automatically update the contacts of respective mobile and smart devices 602 616 when the devices are first used in the local environment. For example, the mobile device 602 may detect and automatically add a device to a contact manager program (e.g., friend device manager 508 in FIG. 5) via an automatic service discovery protocol the first time the target device (e.g., smart device 616) is powered on and coupled to the local network 610. Similarly, if the user wishes, the user contact data (e.g., data associated with the user and the user's primary device 602) may be added to a contact list stored on the smart device 616 for such purposes as alerts, return addressing, etc.

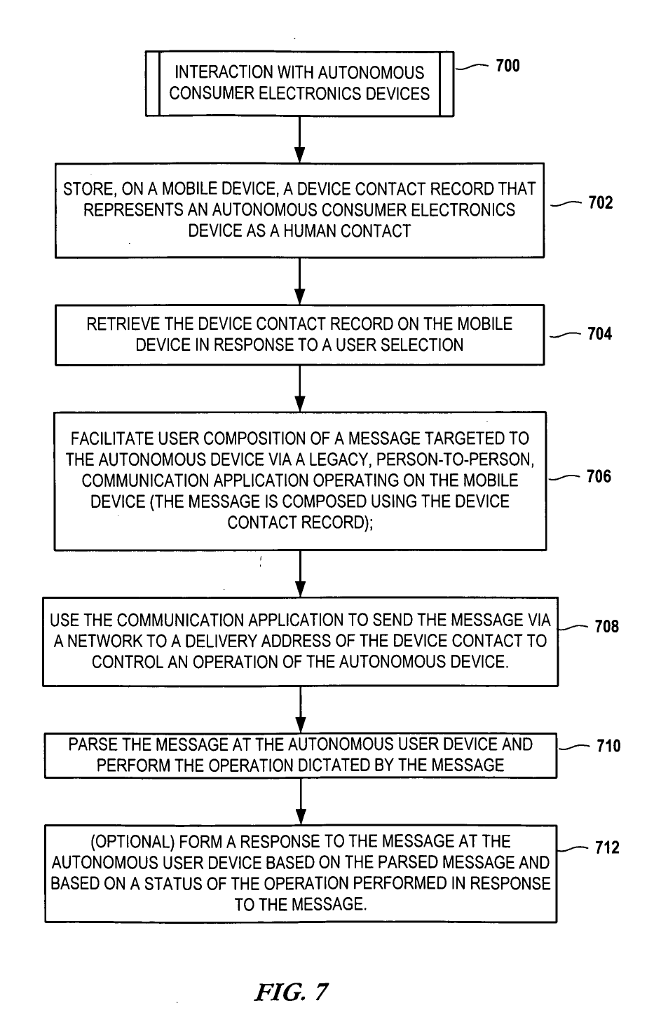

In reference now to FIG. 7, a flowchart illustrates a procedure 700 for interacting with autonomous consumer electronics devices according to an embodiment of the invention. A device contact record is stored 702 on a mobile device. The contact record represents an autonomous consumer electronics device as a human contact. The device contact record is retrieved 704 on the mobile device in response to a user selection. User composition of a message is facilitated 706. The message is targeted to the autonomous device via a legacy, person-to-person, communication application (e.g., email, IM, SMS, MMS, etc.) operating on the mobile device, and the message is composed using the device contact record. Using the communication application, the message is sent 708 via a network to a delivery address of the device contact to control an operation of the autonomous device. The autonomous device parses 710 the message and performs the operation dictated by the message. The autonomous device may optionally form a response to the message based on the parsed message and based on a status of the operation performed in response to the message.

As will be apparent from reading the above disclosure, embodiments of the invention may be implemented using data processing devices. The functionality of these devices may be realized through the use of instructions that are stored to memory and executed on one or more central processing units. These instructions may be stored and distributed in any form known in the art, including computer readable medium such as magnetic or optical media. The instructions may also be transmitted to the target devices via wired or wireless networks.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A mobile apparatus comprising:
at least one network interface;
a processor coupled to the network interface; and
memory coupled to the processor, wherein the memory includes instructions that cause the processor to:
represent an external, network-coupled, autonomous consumer electronics device as a target entity that is commonly accessible by applications of the mobile apparatus, wherein the target entity is presented via a legacy inter-application service that is different from a service associated with the autonomous consumer electronics device;
facilitate user composition of data targeted to the target entity via a selected one of the applications;
select the target entity as a recipient of a user action via the selected application; and
in response to the user action, send the data to the autonomous device via the network interface to cause the service of the autonomous consumer electronics device to respond to the data.

2. The apparatus of claim 1, wherein the legacy inter-application service comprises a contact manager application of the mobile apparatus, and wherein the target entity comprises a device contact record that represents the autonomous consumer electronics device as a human contact.

3. The apparatus of claim 2, and wherein the selected application comprises a person-to-person communication application, and wherein the data comprises a message of the person-to-person communication application.

4. The apparatus of claim 3, wherein facilitating user composition of the data comprises accessing a stored message template that is tailored for the autonomous consumer electronics device.

5. The apparatus of claim 2, wherein the instructions further cause the processor to:
determine, via the network, presence data associated with the autonomous consumer electronics device that describes a present ability of the autonomous consumer electronics device to communicate; and
modify representation of the device contact record based on the presence data.

6. The apparatus of claim 1, wherein the data sent to the autonomous consumer electronics device controls the autonomous device.

7. The apparatus of claim 1, wherein the autonomous consumer electronics device is coupled to an ad-hoc, peer-to-peer network, and wherein the instructions further cause the processor to configure the target entity via the legacy inter-application service based on a service discovery record received at the apparatus via the ad-hoc, peer-to-peer network.

8. A method comprising:
representing, on a mobile device, a target entity that is commonly accessible by applications of the mobile device, wherein the target entity is presented via a legacy inter-application service that is different from a service associated with a target autonomous consumer electronics device;
facilitating user composition of data targeted to the target entity via a selected one of the applications;
facilitating selection of the target entity as a recipient of a user action via the selected application; and
in response to the user action, sending the data via a network to the autonomous consumer electronics device to cause the service of the autonomous consumer electronics device to respond to the data.

9. The method of claim 8, wherein the legacy inter-application service comprises a contact manager application of the mobile device, and wherein the target entity comprises a device contact record that represents the autonomous consumer electronics device as a human contact.

10. The method of claim 9, further comprising:
displaying the device contact record together with human contact records in the contact manager application;
determining, via the network, presence data associated with the autonomous device that describes a present ability of the autonomous device to communicate; and
modifying display of the device contact record based on the presence data.

11. The method of claim 9, wherein the selected application comprises a person-to-person communication application, and wherein the data comprises a message of the person-to-person communication application, the method further comprising:
parsing the message at the autonomous user device;
forming a response message at the autonomous user device based on the parsed message and based on a status of the response of the autonomous consumer electronics device to the message; and
sending the response message to the person-to-person communication application of the mobile device.

12. The method of claim 9, wherein the selected application comprises a person-to-person communication application, and wherein facilitating user composition of the data comprises accessing a stored message template that is tailored for the autonomous consumer electronics device.

13. The method of claim 8, wherein the data sent to the autonomous consumer electronics device controls the autonomous device.

14. The method of claim 8, wherein the autonomous user device is coupled to an ad-hoc peer-to-peer network, the method further comprising presenting the target entity via the legacy inter-application service based on a service discovery record received at the apparatus when the apparatus is coupled to the ad-hoc, peer-to-peer network.

15. An apparatus comprising:
an integrated control circuit;
an interworking agent coupled to the control circuit, the interworking agent comprising a network interface and configured to autonomously:
receive user-composed data targeted to the apparatus via the network interface, wherein the data originates from a legacy inter-application service of a mobile device, wherein the legacy inter-application service is different from a service associated with the integrated control circuit;
parse the data; and
control an operation of the apparatus via the integrated control circuit in response to the parsing of the data in accordance with the service associated with the integrated control circuit.

16. The apparatus of claim 15, wherein the interworking agent is further configured to determine a presence status of the apparatus and communicate the presence status via the network for use by the mobile device.

17. The apparatus of claim 15, and wherein the data comprises a message of a person-to-person communication application of the mobile device.

18. The apparatus of claim 17, wherein the interworking agent is further configured to:
form a response to the message based on the parsed message and based on a status of the operation performed in response to the message; and
send the response to the person-to-person communication application of the mobile device.

19. The apparatus of claim 17, wherein the interworking agent is further configured to receive contact records of the mobile device via the legacy inter-application service.

20. The apparatus of claim 19, wherein the contact records of the mobile device comprise a second device contact record that represents a second apparatus as a second human contact, and wherein the interworking agent is further configured to communicate with the second apparatus using the second device contact record.

21. A system comprising:
a mobile device and an autonomous consumer electronics device capable of being coupled via a network, wherein the mobile device comprises:
means for representing the autonomous consumer electronics device as a target entity that is commonly accessible by applications of the mobile device, wherein the target entity is presented via a legacy inter-application service that is different from a service associated with the autonomous consumer electronics device;
means for facilitating user-composition of data targeted to the target entity via a selected one of the applications;
means for selecting the target entity as a recipient of a user action via the selected application; and
means for sending the data to the autonomous device via the network in response to the user selection; and
wherein the autonomous consumer device comprises:
means for receiving the user-composed data targeted via the network; and
means for controlling an operation of the service of associated with the autonomous consumer electronics device in response to the data.

22. The system of claim 21, further comprising a presence data producer, wherein the presence data producer comprises:
means for receiving presence data from the autonomous consumer device that describes a present ability of the autonomous device to communicate; and
means for communicating the presence data to the mobile device; and
wherein the mobile device further comprises means for modifying the representation of the target entity based on the presence data.

23. The system of claim 22, wherein the network comprises a public network and a private network, and wherein the mobile device is coupled to the public network and the autonomous device is coupled to the private network, the system further comprising an inter-device communications facility that facilitates communications between the mobile device and the autonomous device using multiple protocols.

24. A computer-readable storage medium including instructions executable by a processor of a mobile device for:
representing, via a user entity, a target entity that is commonly accessible by applications of the mobile device, wherein the target entity is presented via a legacy inter-application service that is different from a service associated with a target autonomous consumer electronics device;
facilitating user composition of data targeted to the target entity via a selected one of the applications;
facilitating selection of the target entity as a recipient of a user action via the selected application; and
in response to the user action, sending the data via a network to the autonomous consumer electronics device to cause the service of the autonomous consumer electronics device to respond to the data.
